(19) United States
(12) Patent Application Publication
(10) Pub. No.: US 2017/0017910 A1
(43) Pub. Date: Jan. 19, 2017

(54) License Management System That Ensures Effective Use of License Considering Time Zone of Installed Device and License Management Method

(71) Applicant: Kyocera Document Solutions Inc., Osaka (JP)

(72) Inventors: Takeshi Araya, Osaka (JP); Toru Yasui, Dusseldorf (DE); Takumi Nakamura, Osaka (JP); Koki Nakajima, Osaka (JP); Koji Kubono, Osaka (JP); Hiromasa Akamatsu, Osaka (JP)

(21) Appl. No.: 15/208,622

(22) Filed: Jul. 13, 2016

(30) Foreign Application Priority Data
Jul. 13, 2015 (JP) 2015-139475

(51) Int. Cl. G06Q 10/06; H04N 1/00

(52) U.S. Cl. CPC G06Q 10/06311; H04N 1/00344; H04N 2201/0094

(57) ABSTRACT

A license management system includes an image forming apparatus and a license management server. The license management server includes a group management database, a license management database, a time zone information table, a group management unit, and a license management unit. The group management database stores information indicating an organization to which the license is assigned. The information relates to a group to which the image forming apparatus belongs. The license management database stores information on the license for the group. The time zone information table describes information on a working hour in a time zone where the group is present. When the one working hour ends, the license management unit that re-assigns the license from the group in the ended working hour to the group in another working hour based on the time zone information table, the license management database, and a current time.

### INCORPORATION BY REFERENCE

This application is based upon, and claims the benefit of priority from, corresponding Japanese Patent Application No. 2015-139475 filed in the Japan Patent Office on Jul. 13, 2015, the entire contents of which are incorporated herein by reference.

### BACKGROUND

Unless otherwise indicated herein, the description in this section is not prior art to the claims in this application and is not admitted to be prior art by inclusion in this section.

Manufacturers of copiers, multifunction peripherals (MFPs), printers, and similar devices (hereinafter generally referred to as an image forming apparatus) have performed various kinds of devisal such as constructing and providing a management system to concentratedly manage image forming apparatuses installed at end customers' sites.

For example, a certain disclosed technique does not manage image forming apparatuses of customers by respective service stores but integrally manages the image forming apparatuses by a center. The technique provides the service stores with information to manage a schedule for maintenance and inspection including usage conditions of the image forming apparatuses and peripherals of the image forming apparatuses. This ensures reduction in man-hour of the service stores taken for managing customers' devices.

With a certain disclosed technique, a server obtains customer information and product information of a customer who dealt with a store for a product. The technique extracts another customer with an attribute identical to the customer who dealt and provides product information on the dealt product from the server to the store in charge of the extracted customer.

For effective use of licenses concentratedly managed, for example, a certain disclosed technique requires licenses to use specific functions on an information processing device, and a typical license management device concentratedly manages the licenses. When a certain information processing device does not use the function requiring the license, the license management device changes an assignment of the license from the information processing device that does not use the function to another information processing device that requires the function.

### SUMMARY

A license management system according to one aspect of the disclosure includes an image forming apparatus and a license management server. The image forming apparatus is installed at an end customer's site. The license management server manages a license for a service including a remote maintenance of the image forming apparatus. The license management server includes a group management database, a license management database, a time zone information table, a group management unit, and a license management unit. The group management database stores information indicating an organization to which the license is assigned. The information relates to a group to which the image forming apparatus belongs. The license management database stores information on the license for the group. The time zone information table describes information on a working hour in a time zone where the group is present. The group management unit manages the group using the group management database. When the one working hour ends, the license management unit that re-assigns the license from the group in the ended working hour to the group in another working hour based on the time zone information table, the license management database, and a current time.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an entire image of an environment where a license management system according to one embodiment of the disclosure operates.

FIG. 2 illustrates a concept of groups.

FIG. 3 illustrates a case when a license management server according to the one embodiment is constituted of a general computer.

FIG. 4 illustrates configurations of the groups that share a license and a relationship of time zones.

FIG. 5 illustrates a relationship of working hours in respective time zones.

FIG. 6 illustrates a flow of processes by the license management system according to the one embodiment.

FIG. 7 illustrates configurations of the groups that share the license and a relationship of time zones.

FIG. 8 illustrates a relationship of working hours in respective time zones.

FIG. 9 illustrates a state of sharing the license between the working hours where the respective groups are present.

FIG. 10 illustrates a state of sharing the license between the working hours where the respective groups are present.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

Hereafter, a description will be given of embodiments of the disclosure with reference to the attached drawings.

### First Embodiment

First, the following describes the first embodiment.

### Overall Configuration

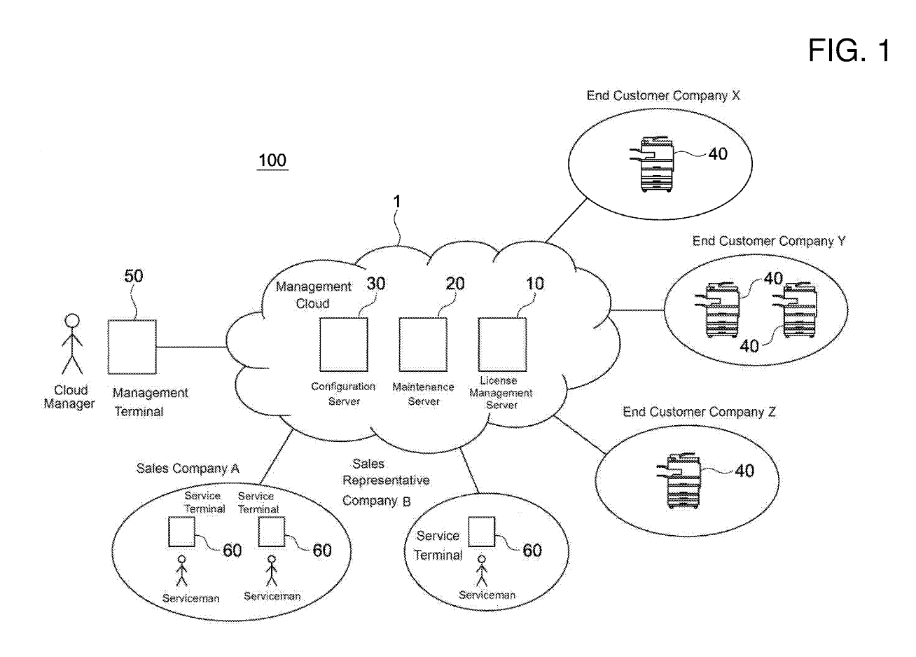

First, the following describes an entire image of an environment where a license management system according to the one embodiment of the disclosure operates. FIG. 1 illustrates the entire image of the environment where a license management system 100 according to the one embodiment of the disclosure operates.

The license management system 100 includes a license management server 10 in a management cloud 1 and an image forming apparatus 40. The image forming apparatus 40 belongs to a group (described later) to be licensed and managed by the license management server 10.

The management cloud 1 includes a configuration server 30 and a maintenance server 20. The configuration server 30 manages a configuration of the image forming apparatus 40 managed by the management cloud 1 under contracted license. The maintenance server 20 maintains the image forming apparatus 40 that the management cloud 1 managed by the management cloud 1 under contracted license.

A cloud manager accesses the management cloud 1 from a management terminal 50, which manages the management cloud 1, to manage the management cloud 1.

The management cloud 1 remotely manages the image forming apparatuses 40 installed at and used by end customers Company X, Company Y, and Company Z over a network.

Servicemen (salespersons may be included) from Sales Company A and Sales Representative Company B become users of the management cloud 1 to perform maintenance and a similar operation of the image forming apparatuses 40 of the respective end customers. The serviceman accesses the management cloud 1 via a service terminal 60 to remotely maintain the image forming apparatuses 40 installed at sites in the respective end customers or to perform a similar operation.

The entire image of the environment where the license management system 100 according to the one embodiment of the disclosure operates is described above.

### Group

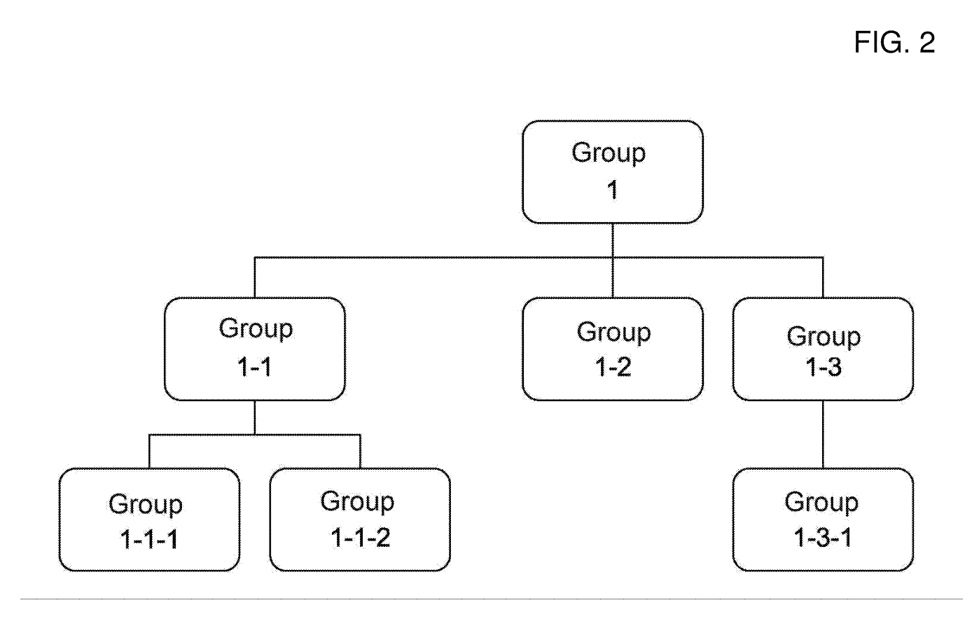

The following describes a concept of the groups. FIG. 2 illustrates the concept of the groups.

The license management server 10 according to the one embodiment of the disclosure uses the concept of groups for management of the licenses to maintain the image forming apparatuses 40 or to perform a similar operation.

The groups are stratified in a tree structure.

The group is a unit to which the license is assigned and basically assumes one independent company organization. The above-described users can belong to the groups.

The image forming apparatus 40 target for management belongs to the group.

The vertical hierarchy in FIG. 2 may indicate, for example, an inclusion relationship of business areas of sales companies or similar companies.

The concept of the groups is described above.

### Configuration of License Management Server

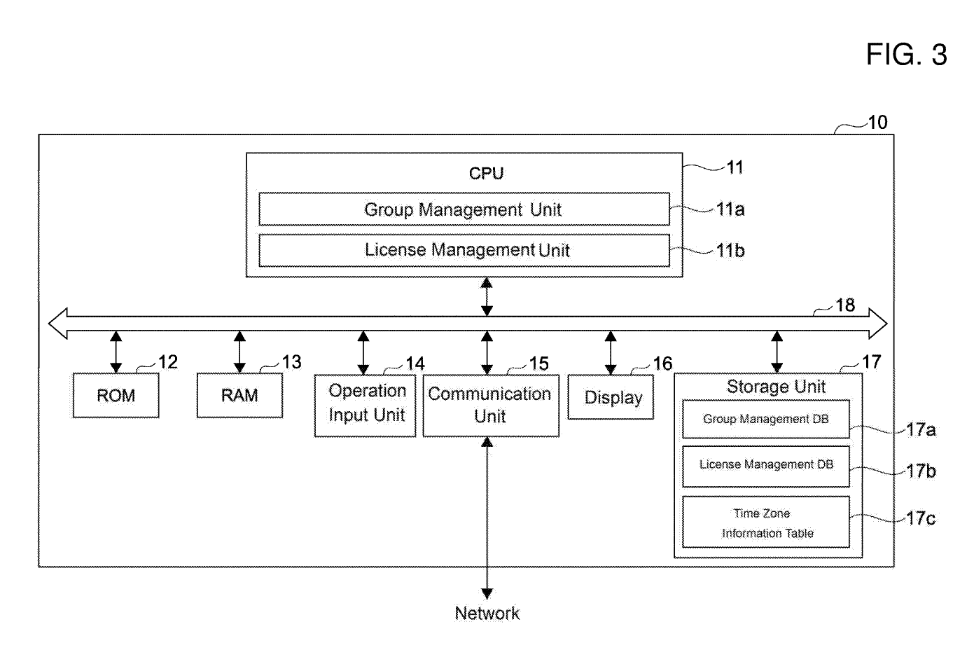

The following describes the configuration of the license management server 10. The license management server 10 may be constituted of dedicated hardware and software or may be constituted of a general computer. FIG. 3 illustrates a case when the license management server 10 according to the one embodiment is constituted of the general computer.

As illustrated in FIG. 3, the license management server 10 includes a central processing unit (CPU) 11, a read only memory (ROM) 12, a random access memory (RAM) 13, an operation input unit 14, a communication unit 15, a display 16, and a storage unit 17. These respective blocks are connected via a bus 18.

The ROM 12 stores a plurality of programs such as firmware and data for executing various processes. The RAM 13 is used as a working area for the CPU 11 and temporarily holds an operating system (OS), various applications during execution, and various pieces of data during processing.

The storage unit 17 is, for example, a hard disk drive (HDD), a flash memory, or other non-volatile memories. The storage unit 17 stores a group management database (DB) 17a, which manages OS's, various applications, various pieces of data, and the groups, a license management DB 17b, which manages the licenses, and a time zone information table 17c.

The group management DB 17a stores information to manage the groups and similar information.

The license management DB 17b stores information to manage the assignment of the licenses and similar information.

The license management server 10 uses the time zone information table 17c to assign the license to the groups present in the respective time zones.

The communication unit 15 is connected to a network for exchanging information with the maintenance server 20, the configuration server 30, the image forming apparatus 40, the management terminal 50, and the service terminal 60.

The CPU 11 loads a program corresponding to an instruction given from the operation input unit 14 among the plurality of programs stored in the ROM 12 and the storage unit 17 to the RAM 13. The CPU 11 appropriately controls the display 16 and the storage unit 17 according to this loaded program.

The operation input unit 14 is, for example, a pointing device such as a computer mouse, a keyboard, a touch panel, and other operating devices.

The display 16 is, for example, a liquid crystal display, an electro-luminescence (EL) display, a plasma display, or a similar display.

The following describes function blocks achieved by execution of the program by the CPU 11.

The function blocks achieved by the CPU 11 in the license management server 10 are a group management unit 11a and a license management unit 11b.

The group management unit 11a uses the group management DB 17a to manage the groups.

The license management unit 11b uses the license management DB 17b to manage the licenses assigned to the groups. The license management unit 11b uses the time zone information table 17c to manage sharing and the assignment of the licenses between the groups present in different time zones.

The configuration of the license management server 10 is described above.

### Example of Groups and Time Zones

The following describes an example where the groups managed by the management cloud 1 are present in time zones different from one another and the license management server 10 transfers the license assigned to the groups between the time zones.

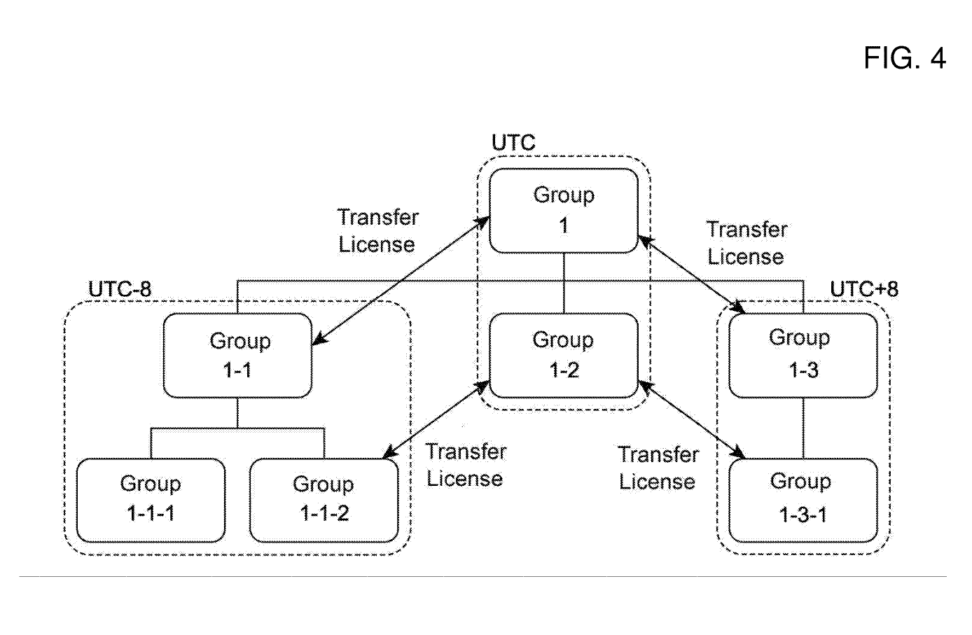

First, the following describes configurations of the groups that share the license and a relationship of the time zones. FIG. 4 illustrates the configurations of the groups that share the license and the relationship of the time zones.

As illustrated in this drawing, it is assumed that Group 1 and Group 1-2 are in a time zone Coordinated Universal Time (UTC) area (West Europe).

It is assumed that Group 1-1, Group 1-1-1, and Group 1-1-2 are in a time zone UTC−8 area (North America West Coast).

It is assumed that Group 1-3 and Group 1-3-1 are in a time zone UTC+8 area (China).

For example, the license assigned to Group 1-1 is re-assigned to Group 1 and is further re-assigned between Group 1 and Group 1-3 as the time elapses.

The license assigned to Group 1-1-2 is re-assigned between Group 1-2 and Group 1-3-1.

Basically, one license is assigned to one group. The number of groups present in UTC−8 is three; therefore, the number is larger than the number of groups present in the other time zones by one. Therefore, the license is fixedly assigned to Group 1-1-1, and the license is not shared.

The configurations of the groups that share the license and the relationship of the time zones are described above.

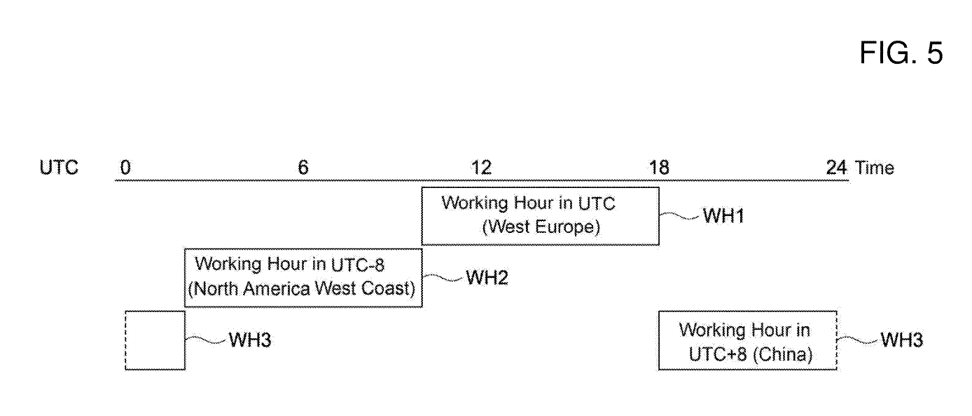

The following describes a relationship of working hours (time slots during which the image forming apparatuses 40 are used) in respective time zones. FIG. 5 illustrates the relationship of the working hours in the respective time zones.

For example, in the UTC area (West Europe), from ten until eighteen in UTC (from 10 a.m. until 6 p.m. in local time) is defined as a working hour WH1. During this time slot, the license is assigned from the license management server 10.

The groups present in West Europe have no license in time slots other than the working hour WH1. Therefore, the image forming apparatuses 40 belonging to groups in West Europe cannot use a function that requires the license. The same applies to groups in other time zones.

For example, in the UTC+8 area (China), from eighteen until two on the following day in UTC (from 10 a.m. until 6 p.m. in local time) is defined as a working hour WH3. During this time slot, the license is assigned from the license management server 10.

With the above-described example, the license is efficiently shared between the respective working hours without gap.

Thus, assume the case where the groups managed by the license management server 10 are in several time zones. In this case, when a working hour ends in one time zone, the license is re-assigned to a group present in a time zone including a working hour starting subsequently. This ensures effortlessly sharing the one license between the plurality of groups.

The above-described example shows the example where the groups in the three time zones share the one license; however, this should not be constructed in a limiting sense. As long as the time zones are two or more, the license can be shared.

The example where the groups managed by the management cloud 1 are present in the time zones different from one another and the license management server 10 transfers the license assigned to the groups between the time zones is described above.

### Flow of Processes

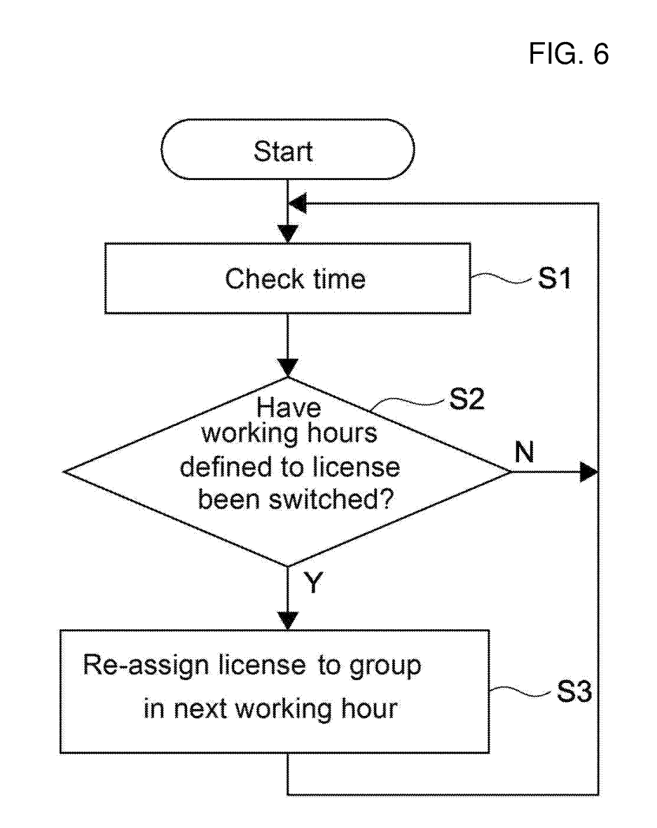

The following describes the flow of processes by the license management system 100. FIG. 6 illustrates the flow of the processes by the license management system 100 according to the one embodiment.

First, the license management unit 11b checks the current time (Step S1). The current time may be obtained from a clock built into the license management server 10 or may be obtained from the outside. The time zone of the current time, for example, may be unified to the UTC time and managed.

Next, the license management unit 11b refers to the license management DB 17b and the time zone information table 17c using the obtained current time to determine whether the working hours of the respective groups defined in the license have been switched or not (Step S2).

When the working hours are not switched (N at Step S2), the license management unit 11b returns to Step S1 and repeats the process.

When the working hours are switched (Y at Step S2), the license management unit 11b recovers the license from the group whose working hour has terminated and re-assigns the license to a group whose working hour newly starts (Step S3). After the reassignment, the license management unit 11b returns to Step S1 and repeats the process.

The flow of processes by the license management system 100 is described above.

The first embodiment is described above.

### Second Embodiment

The second embodiment, which differs from the first embodiment, does not re-assign the license at a time point where one working hour ends but re-assigns the license to the group in the next working hour while the image forming apparatuses 40 belonging to the groups are not used any more even in the middle of the previous working hour.

It is only necessary to use a well-known technique or a similar technique as a mechanism to detect an unused state of the image forming apparatuses 40 in the previous working hour; therefore, the following omits the description.

### Example of Groups and Time Zones

The following describes an example where the groups managed by the management cloud 1 are present in time zones different from one another and the license management server 10 transfers the license assigned to the groups between the time zones.

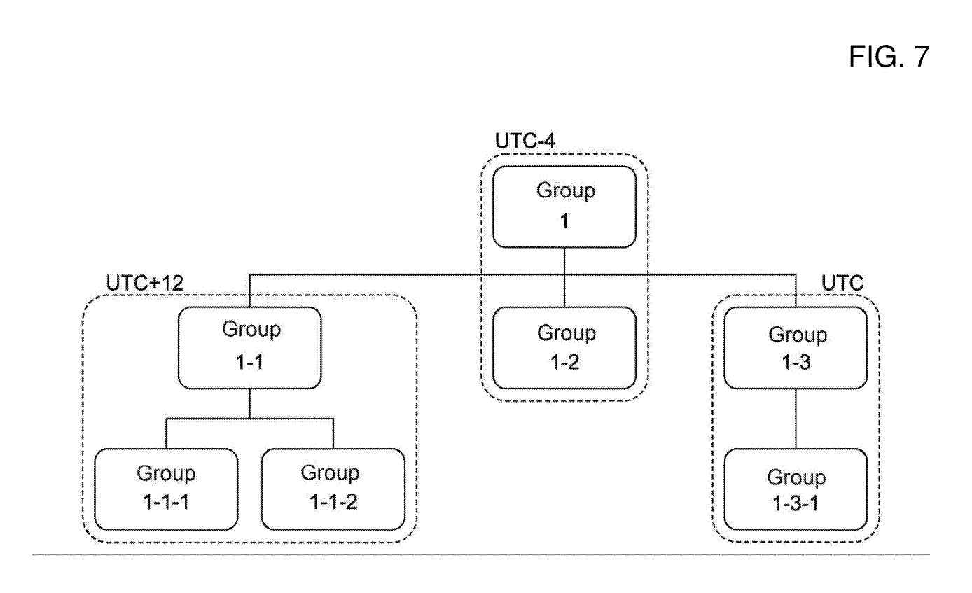

First, the following describes configurations of the groups that share the license and a relationship of the time zones. FIG. 7 illustrates the configurations of the groups that share the license and the relationship of the time zones.

As illustrated in this drawing, it is assumed that Group 1 and Group 1-2 are in a time zone UTC−4 area (Canada).

It is assumed that Group 1-1, Group 1-1-1, and Group 1-1-2 are in a time zone UTC+12 area (New Zealand).

It is assumed that Group 1-3 and Group 1-3-1 are in the time zone UTC area (West Europe).

For example, when the image forming apparatuses 40 belonging to Group 1-1 are not used any more, the license assigned to Group 1-1 is re-assigned to groups in another time zone.

Similar to the first embodiment, the license is fixedly assigned to Group 1-1-1, and the license is not shared.

The configurations of the groups that share the license and the relationship of the time zones are described above.

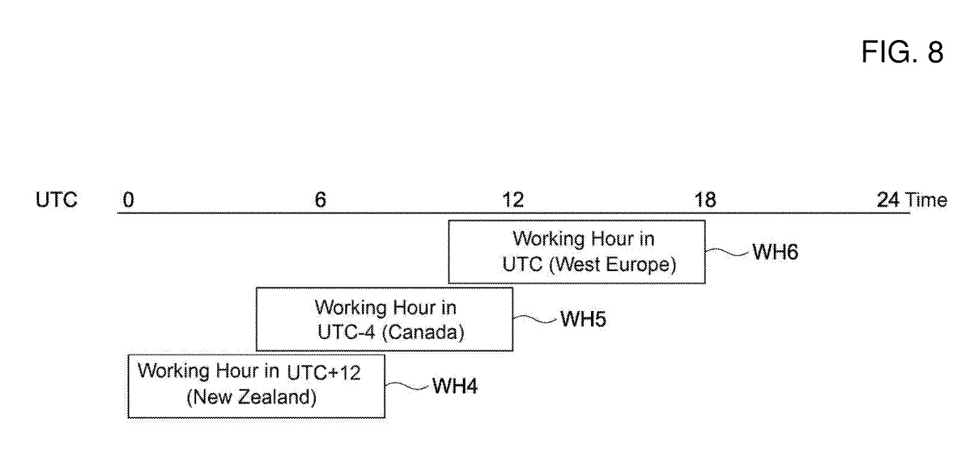

The following describes a relationship of working hours in respective time zones. FIG. 8 illustrates the relationship of the working hours in the respective time zones.

From midnight (zero) until eight in the UTC time corresponds to from 10 a.m. until 6 p.m. in local time in the UTC+12 area (New Zealand) defined as a working hour WH4. From four to twelve in the UTC time corresponds to from 10 a.m. until 6 p.m. in local time in the UTC−4 area (Canada) defined as a working hour HW5.

From ten until eighteen in the UTC time corresponds to from 10 a.m. until 6 p.m. in local time in the UTC area (West Europe) defined as a working hour WH6.

Thus, in the example employed in the second embodiment, the working hours for the groups that share the license overlap with one another.

In this case, when the license management unit 11b of this embodiment detects an unused state of the image forming apparatuses 40 belonging to the groups present in the working hour WH4 in UTC+12, the license management unit 11b re-assigns the license to groups in the working hour WH6 in UTC (West Europe) with which the working hour does not overlap.

The reason that the license is not re-assigned from the groups in the working hour WH4 to the groups in a working hour WH5 is as follows.

For example, assume that, when the license is re-assigned from the image forming apparatus 40 in the working hour WH4 to the group in another working hour at a time point of five in the UTC time, the image forming apparatus 40 in the working hour WH4 needs to be used once again at six in the UTC time.

In this case, to recover the already re-assigned license, recovering the license from the working hour WH6 whose local time is 5 a.m. and therefore a probability of practical use of the image forming apparatus 40 is low ensures decreasing problems occurred in association with the recovery rather than recovering the license from the working hour WH5 whose local time is 11 a.m. and therefore a probability of practical use of the image forming apparatus 40 is high.

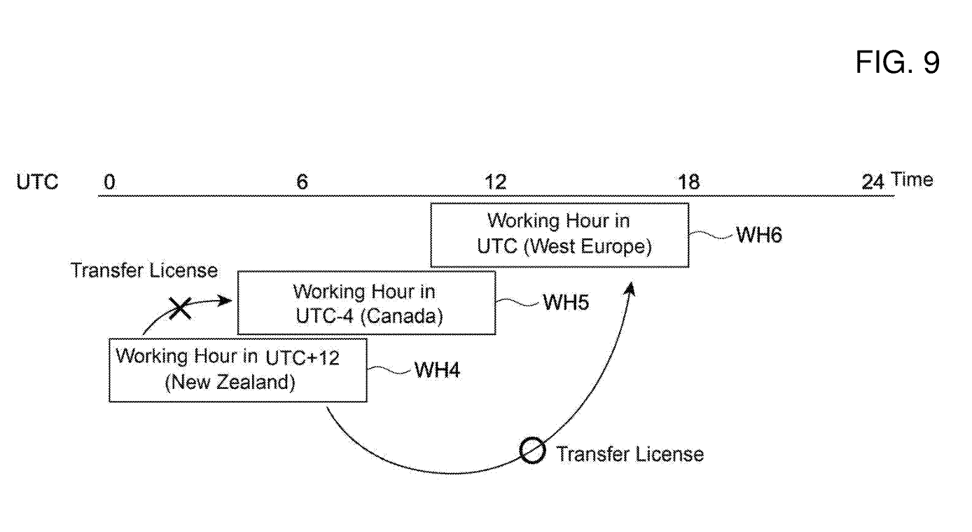

Thus, in the second embodiment, when the image forming apparatus 40 is not used any more, the license is re-assigned to the groups in the subsequent working hour. At this time, sharing the license between the groups in the working hours whose time slots do not overlap ensures the reduced problem in a situation where the license is returned to the groups in the previous working hour occurs (see FIG. 9).

The example where the groups managed by the management cloud 1 are present in the time zones different from one another and the license management server 10 transfers the license assigned to the groups between the time zones is described above.

The second embodiment is described above.

### Third Embodiment

The third embodiment improves a problem that occurs in overlapped working hours, which is raised as the problem in the second embodiment.

The example of the configurations of the groups and the working hours employed in the third embodiment is identical to that of the second embodiment.

A point different from the second embodiment is as follows. Among the three working hours WH4, WH5, and WH6, which overlap with one another, a right of preferentially assigning the license is given to the groups present in the working hour WH5 in UTC−4 (Canada), which is located in the middle.

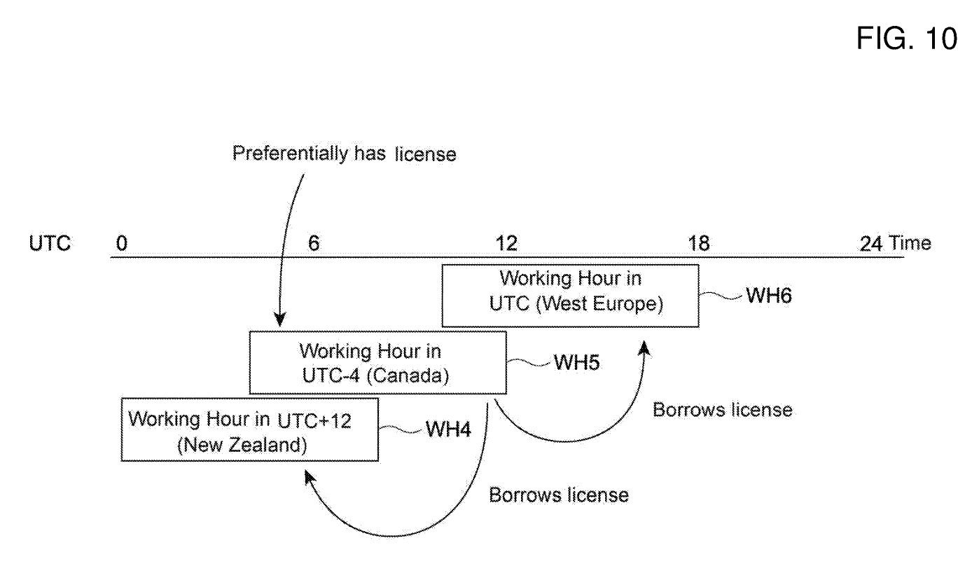

The groups in the working hour WH4 in New Zealand and the groups in the working hour WH6 in West Europe have a configuration that temporarily borrows the license from the groups with a right of priority (see FIG. 10). When the two or more groups present in different working hours require one license, this configuration ensures appropriate reassignment of the license in accordance with the priority orders.

Thus, giving the priority orders for the assignment of the license ensures easily solving the problem regarding the assignment of the license between the groups present in the working hours overlapped with one another.

The third embodiment is described above. Thus, this embodiment ensures an effective use of the license considering the time zone of the installed device.

### Supplementary Note

As described above, the license management system 100 according to the disclosure includes the image forming apparatus 40 installed at an end customer's site and the license management server 10. The license management server 10 manages a license for a service such as a remote maintenance of the image forming apparatus 40. The license management server 10 includes the group management database 17a, the license management database 17b, the time zone information table 17c, the group management unit 11a, and the license management unit 11b. The group management database 17a stores information indicating an organization to which the license is assigned. The information relating to a group to which the image forming apparatus 40 belongs. The license management database 17b stores information on the license for the group. The time zone information table 17c describes information on a working hour in a time zone where the group is present. The group management unit 11a manages the group using the group management database 17a. The license management unit 11b re-assigns the license from the group in the ended working hour to the group in the other working hour when the one working hour ends based on the time zone information table 17c, the license management database 17b, and the current time.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A license management system comprising:
an image forming apparatus installed at an end customer's site; and
a license management server that manages a license for a service including a remote maintenance of the image forming apparatus, the license management server including
a group management database that stores information indicating an organization to which the license is assigned, the information relating to a group to which the image forming apparatus belongs,
a license management database that stores information on the license for the group,
a time zone information table that describes information on a working hour in a time zone where the group is present,
a group management unit that manages the group using the group management database, and
a license management unit that re-assigns, when the one working hour ends, the license from the group in the ended working hour to the group in another working hour based on the time zone information table, the license management database, and a current time.

2. The license management system according to claim 1, wherein when the one working hour ends and the license management unit re-assigns the license from the group in the ended working hour to the group in the other working hour, the license management unit re-assigns the license to the group in the working hour that does not overlap the ended working hour.

3. The license management system according to claim 1, wherein:
the working hours are described in the time zone information table with priority orders; and
the license management unit re-assigns the license to the groups based on the priority orders.

4. A license management method for managing a license of an image forming apparatus installed at an end customer's site and a license management server, the license management method comprising:
via the license management server, managing a license for a service including a remote maintenance of the image forming apparatus, wherein the license management server includes
a group management database that stores information indicating an organization to which the license is assigned, the information relating to a group to which the image forming apparatus belongs,
a license management database that stores information on the license for the group, and
a time zone information table that describes information on a working hour in a time zone where the group is present; and
re-assigning, when the one working hour ends, the license from the group in the ended working hour to the group in another working hour based on the time zone information table, the license management database, and a current time.
